(19) United States
(12) Patent Application Publication
(10) Pub. No.: US 2003/0167282 A1
(43) Pub. Date: Sep. 4, 2003

(54) Method and system for locating cellular phone numbers

(76) Inventor: Scott C. Nance, Las Vegas, NV (US)

Correspondence Address: WEISS & MOY PC, 4204 NORTH BROWN AVENUE, SCOTTSDALE, AZ, 85251, US

(21) Appl. No.: 10/086,263

(22) Filed: Mar. 4, 2002

(51) Int. Cl. G06F 7/00

(52) U.S. Cl. 707/104.1

(57) ABSTRACT

A method and system for locating cellular phone numbers by creating a database of cellular phone numbers and corresponding cellular phone users and providing searchable access to the database by a user.

### FIELD OF THE INVENTION

The present invention relates generally to telephone directory systems, and more specifically, to a method and system for locating cellular phone numbers by creating a directory of cellular phone users with their corresponding cellular phone numbers.

### BACKGROUND OF THE INVENTION

Phone books, operator-assisted information phone calls and other directories are used by people to locate the telephone number of a specific company or person by looking up their name. Phone books and internet directories are generally free, deriving their revenue from advertising. Operator-assisted phone calls, on the other hand, are generally fee-based. In either case, phone directories provide an invaluable service, furthering commerce and personal relationships by providing people with the means with which to communicate with each other.

Cellular phones, beepers and internet-connected personal digital assistants are becoming increasingly prevalent in society. More and more people use cellular phones as their primary means for telephonic communication. With people enjoying increased personal mobility, the cellular phone is becoming the preferred mechanism for maintaining an open line of communication. While the Yellow Pages may include cellular phone numbers or beeper numbers as part of an advertisement, personal directories, such as the White Pages, do not provide the cellular phone numbers of the people listed in the directory. Without a cellular phone directory, acquiring the cellular phone number of a particular individual is a time-consuming process, often requiring a little detective work. The result is a barrier in the ability of people to connect with one another in an increasingly mobile world. A need therefore existed for a method and system for locating cellular phone numbers that is capable of providing public access to a database listing the names of cellular phone users with their corresponding cellular phone numbers.

### SUMMARY OF THE INVENTION

An object of the present invention is to provide a method and system for providing public access to a database having cellular phone users listed with their corresponding cellular phone numbers. The method may be embodied in a computer program product for performing the method within a general purpose computer.

The foregoing and other objectives, features, and advantages of the invention will be apparent from the following, more particular, description of the preferred embodiment of the invention, as illustrated in the accompanying drawings.

### BRIEF DESCRIPTION OF THE DRAWINGS

FIG. 1 is a block diagram depicting a cellular phone directory system in which a preferred embodiment of the invention may be practiced.

FIG. 2 is a flowchart depicting operation of a cellular phone number directory system in accordance with a preferred embodiment of the invention.

### DETAILED DESCRIPTION OF THE PREFERRED EMBODIMENTS

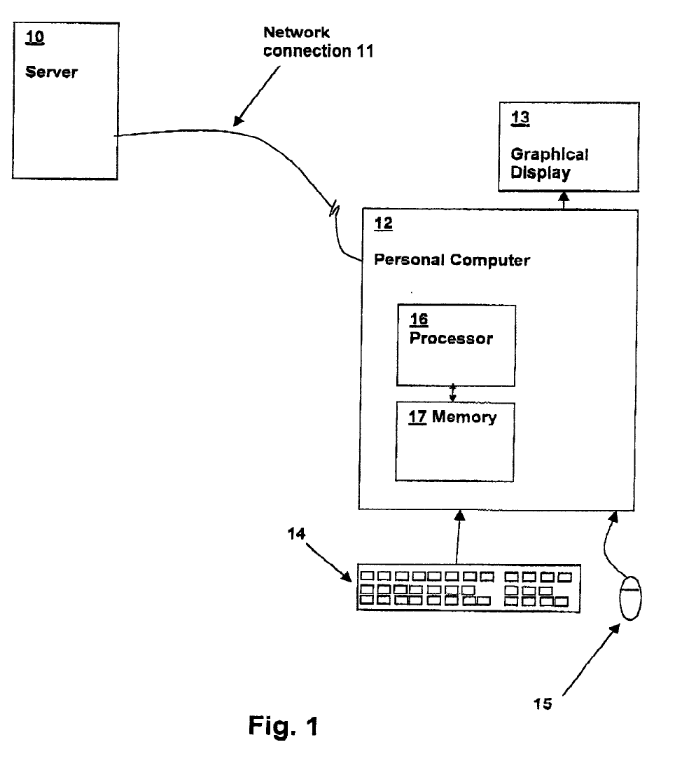

Referring now to the figures and in particular to FIG. 1, a networked computer system within which a preferred embodiment of the present invention may be practiced is depicted in a block diagram. To support database functions, a server 10 is coupled to the network via a network connection 11. Also coupled to the network is a personal computer 12 having a processor 16 coupled to a memory 17 for executing program instructions from memory 17. Personal computer 12 is coupled to a graphical display 13 for displaying program output and input devices such as a mouse 15 and a keyboard 14 for receiving user input. The networked computer system may be coupled to a public network such as the Internet, or may be a private network such as the various “intra-nets” that are implemented within corporate offices and other installations requiring secure data communications.

Within memory 17, a program embodying a method in accordance with a preferred embodiment of the present invention is executed by processor 16. Personal computer 12 is included to provide a demonstrative example of a general purpose computer, and it will be understood by those skilled in the art that the techniques of the present invention apply to a variety of other network applications such as dedicated Internet appliances and large mainframe computers having user terminals. The present invention also applies to personal digital assistants (PDAs), pagers and cellular telephones.

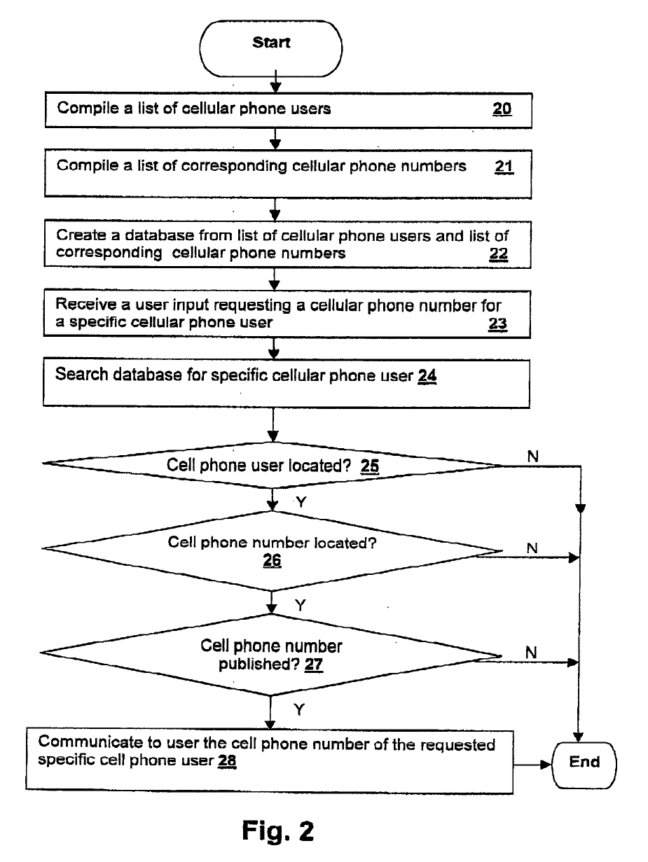

Referring now to FIG. 2, the system for locating cellular phone numbers of the present invention is depicted in a flowchart. A list of cellular phone users is compiled from at least one service provider (step 20). A list of corresponding cellular phone numbers of the cellular phone users is compiled (step 21). A database is then created of the cellular phone users and the corresponding cellular phone numbers of the cellular phone users (step 22). When someone using the system provides a user input requesting a cellular phone number of a specific cellular phone user (step 23), the database is searched for the name of the specific cellular phone user (step 24). If the name of the specific cellular phone user is found (decision 25) and the cellular phone number corresponding to the cellular phone user is found (decision 26) and the cellular phone number is published (it has not been requested to be unpublished by the cellular phone user) (decision 27) the cellular phone number of the requested specific cellular phone user is communicated to the user (step 28), otherwise the user is not provided with the cellular phone number for the specific cellular phone user. Note that the exemplary system depicted in the flowchart of FIG. 2 may be implemented in a variety of fashions, such as skipping the phone number publication check (step 27). For example, the database may include only published cellular phone numbers, thus negating the need to determine whether a cellular phone number is published. In addition, the method for locating cellular phone numbers may be embodied in a computer program, a cellular phone directory or some other medium, so long as the database of cellular phone users and corresponding cellular phone numbers is able to be searched by a user.

In the preferred embodiment, the database is organized as an alphabetical directory, according to the names of the cellular phone users, although it should be clearly understood that substantial benefit could be derived from an alternative embodiment of the method for locating cellular phone numbers in which the database is organized by a different format, such as by cellular phone number. The database or alphabetical directory may be published in a phone book, on CD-ROM, in an electronic network (such as the internet), as part of an operator-assisted dial-in service or by some other means which allows a user to conveniently search the database.

Revenue can be generated from the method for locating cellular phone numbers by soliciting advertising in the alphabetical directory. Alternatively, if the database is part of an operator-assisted dial-in service, a fee may be charged per search. The database or alphabetical directory is derived from at least one cellular phone provider, although it should be clearly understood that a single database could be based on multiple cellular phone providers, or multiple databases could be used, one for each cellular phone provider. In the preferred embodiment, cellular phone users who do not want to provide public access to their corresponding cellular phone numbers may request that their numbers be unpublished, thus requiring the additional step of tagging cellular phone numbers as unpublished in the database in order to prevent them from being accessed. While, in the preferred embodiment, the method for locating a cellular phone number includes the tagging of cellular phone numbers as unpublished, it should be clearly understood that substantial benefit could be derived from an alternative embodiment of the present invention in which there is no tagging of cellular phone numbers as unpublished.

While the invention has been particularly shown and described with reference to the preferred embodiments thereof, it will be understood by those skilled in the art that the foregoing and other changes in form, and details may be made therein without departing from the spirit and scope of the invention.

What is claimed is:

1. A method for locating cellular phone numbers comprising, in combination, the steps of:
compiling a list of cellular phone users from at least one cellular phone provider;
compiling a list of corresponding cellular phone numbers of said cellular phone users;
creating a database of said list of said cellular phone users and said list of corresponding cellular phone numbers of said cellular phone users; and
a user searching said database.

2. The method of claim 1 wherein said database is an alphabetical directory of said cellular phone users and said corresponding cellular phone numbers.

3. The method of claim 2 wherein said alphabetical directory is published in an electronic network.

4. The method of claim 2 wherein said alphabetical directory is published in a phone book.

5. The method of claim 2 wherein said alphabetical directory is published in a CD-ROM.

6. The method of claim 2 further comprising the step of generating revenue by soliciting advertising in said alphabetical directory.

7. The method of claim 2 further comprising the step of publishing a separate alphabetical directory for separate cellular phone providers.

8. The method of claim 2 further comprising the steps of:
compiling a list of cellular phone users of a first cellular phone provider;
compiling a list of cellular phone users of at least a second cellular phone provider;
compiling a list of cellular phone numbers of said cellular phone users of said first cellular phone provider;
compiling a list of cellular phone numbers of said cellular phone users of said at least a second cellular phone provider;
merging said list of cellular phone users and corresponding cellular phone numbers of said first cellular phone provider with said list of cellular phone users and corresponding cellular phone numbers of said at least a second cellular phone provider; and
creating an alphabetical directory of all cellular phone users and corresponding cellular phone from said first cellular phone provider and said at least a second cellular phone provider.

9. The method of claim 1 further comprising the steps of:
tagging cellular phone numbers as unpublished at the request of corresponding cellular phone users; and
removing unpublished cellular phone numbers from said list of corresponding cellular phone numbers of said cellular phone users.

10. The method of claim 1 wherein said database is available to be searched through a dial-in cellular phone directory capable of allowing said user to call a designated directory number and request a cellular phone number corresponding to a name of a cellular phone user.

11. The method of claim 10 wherein said dial-in cellular phone directory is operated by a voice-recognition computer.

12. The method of claim 10 wherein said dial-in cellular phone directory is operated by a person.

13. The method of claim 2 wherein said alphabetical directory is capable of being downloaded to a cellular phone.

14. The method of claim 2 wherein said alphabetical directory is capable of being downloaded to a computer.

15. The method of claim 2 wherein said alphabetical directory is capable of being downloaded to a personal digital assistant.

16. A system for locating cellular phone numbers, comprising, in combination;
a memory for storing program instructions and data;
a processor coupled to said memory for executing said program instructions; and
a user input device coupled to said processor for receiving user input, wherein said program instructions include instructions for
compiling a list of cellular phone users from at least one cellular phone provider;
compiling a list of corresponding cellular phone numbers of said cellular phone users;
creating a database of said list of said cellular phone users and said list of corresponding cellular phone numbers of said cellular phone users;
receiving a user input requesting a cellular phone number of a specific cellular phone user;
searching said database for a name of said specific cellular phone user;
locating said name of said specific cellular phone user from said list of cellular phone users from at least one cellular phone provider;
matching said name of said specific cellular phone user from said list of cellular phone users from at least one cellular phone provider with said corresponding cellular phone number of said cellular phone user; and
generating a response to communicate to a user a corresponding cellular phone number of said name of said specific cellular phone user from said database of said list of cellular phone users and said list of corresponding cellular phone numbers of said cellular phone users.

17. The system of claim 16 wherein said response is communicated to a user audibly.

18. The system of claim 16 wherein said response is communicated to a user textually.

19. The system of claim 16 wherein said response to communicate to a user comprises a message that no corresponding phone number exists for said specific cellular phone user.

20. The system of claim 16 wherein said response no communicate to a user comprises a message that said at corresponding phone number for said specific cellular phone user is unpublished.
